(19) United States
(12) Patent Application Publication
(10) Pub. No.: US 2006/0259516 A1
(43) Pub. Date: Nov. 16, 2006

(54) Nondisruptive method for encoding file meta-data into a file name

(76) Inventors: Christopher J. Stakutis, Concord, MA (US); Kevin M. Stearns, Maynard, MA (US)

Correspondence Address: Bradley K. Lortz;Origin Law, Suite 208, 333 N. Indian Hill Blvd., Claremont, CA, 91711, US

(21) Appl. No.: 11/127,691

(22) Filed: May 11, 2005

(51) Int. Cl. G06F 17/30

(52) U.S. Cl. 707/200

(57) ABSTRACT

A method and article of manufacture for encoding file metadata into a file name used in a computer system is disclosed. Metadata is added to an original file name and extension created by a user. The metadata may be in the form of a left padded, monotonically increasing number which operates similar to a time stamp. The file extension is then duplicated following a delimiter to preserve a user's ability to search for the original file name and extension, while maintaining functional identification of the file type to the operating and/or file system.

### BACKGROUND OF THE INVENTION

1. Field of the Invention

This invention relates to computer files systems. More specifically, this invention relates to encoding information, particularly application information, in file names used in a computer system.

2. Description of the Related Art

Computer systems continue to evolve. Over time, numerous new uses and improvements to enhance their convenient use and efficiency have been devised. New uses may come in the form of novel software applications and peripherals as well as. In another arena, many improvements are directed to more fundamental aspects of computer systems which are universally employed. For example, the graphical user interface (GUI) or text interface and file management systems are integral to almost any computer system.

For software applications which enhance file systems by adding new services, identifying places to store additional file information (e.g. as metadata) can be challenging. For example, a source-code control system is one example of an application that may store “metadata” about files (e.g. to track versions of the files) with an ancillary database. One known approach is to encode the additional information into the file name itself. This approach has advantages but if it is not properly implemented, it may function counter to users' expectations. For example, the file name may be altered such that the file can no longer be located by the complete original file name. Prior art approaches tend to alter the file name in locations in a manner which makes them more cumbersome to be used. A common techniques for adding “extra” meta information to file names is to allow multiple instances of a given file (versions) to be stored, co-located within a common location or directory. Some patents and publications related to techniques for encoding file metadata in a file name which are deficient in satisfying one or more of the aforementioned needs are described hereafter.

PCT Publication No. WO 03/52629 to Rogers discloses a method and system that automatically names and stores electronic files by associating metadata with the files. The metadata is stored in the header of each file, and the metadata automatically designates file names and locations to each file. A user interface allows a user to input and edit files. A Java Virtual Machine is started up upon boot-up and runs a Java Main thread, which creates the user interface. A Java database-access thread, spawned from the Java main thread, queries storage devices as to availability to receive files. A message is returned to the user confirming the status of the attempted file save function.

U.S. Patent Publication No. 2003/0200193 to Boucher discloses a fast access system for data stored in a file system. Because there is typically far less overhead with the fast access system than a conventional file system, the fast access system provides a substantial boost in data access efficiency. File names themselves in the fast access system store data for later retrieval. As a result, the file system may retrieve metadata maintained in the file system, rather than opening the file itself, to obtain the data. Thus, the methods and systems accelerate retrieval of data by avoiding significant overhead that would be required for a conventional file system to open and read data from a file.

U.S. Patent Publication No. 2004/54906 to Carro discloses a method and system for verifying the authenticity and integrity of files transmitted through a computer network. Authentication information is encoded in the filename of the file. In a preferred embodiment, authentication information is provided by computing a hash value of the file, computing a digital signature of the hash value using a private key, and encoding the digital signature in the filename of the file at a predetermined position or using delimiters, to create a signed filename. Upon reception of a file, the encoded digital signature is extracted from the signed filename. Then, the encoded hash value of the file is recovered using a public key and extracted digital signature, and compared with the hash value computed on the file. If the decoded and computed hash values are identical, the received file is processed as authentic.

PCT Publication No. WO 2004/049199 to Carro discloses methods and systems for hyperlinking files. According to the method of the invention, a set of target files is linked to a main file by encoding the target addresses or URLs of these target files into the primary filename of the main file. Separator characters are used to distinguish the primary filename of the main file and the encoded address of each linked target file. Linked target files may be of any kind including, source files of the main file, metadata, multimedia information and services. Since most file systems do not accept certain characters on valid filenames, addresses of linked target files are encoded so that any forbidden character is replaced by an associated authorized character. A lexicography table stores all pairs of forbidden and corresponding authorized characters. Likewise, since filenames length is generally limited to 256 characters, the encoding process may be optimized to reduce the length of the encoded addresses or URLs.

Despite the foregoing teachings, there remains a need in the art for encoding additional information into a file name while still allowing users to search for their file name (and any related files) using the most natural (intuitive) methods. In addition the encoded additional information should allow users to find their file name (and any related files) in a sorted list. Thus, sort order should be unaffected by the encoded additional information. Finally, the encoded additional information should also allow users to launch and edit their files in a manner they are accustomed to, e.g. double-clicking the files. Thus, the encoded additional information should not be significant enough to impact familiar user operation. As detailed hereafter, these and other needs are met by various embodiments of the present invention.

### SUMMARY OF THE INVENTION

The present invention satisfies the aforementioned needs by encoding information in a computer system file name in the following manner. A user creates a file, typically giving it a name including an extension, e.g. test.doc. The file name extension is typically separated from the root name by a delimiter, commonly a dot or period, “.”. In response, a file system application may automatically add its own data to the file name, beginning with the original file name and then appending its metadata then a delimiter. Following the delimiter, the file system application then repeats the file extension that the user originally applied. Thus, metadata is added to an original file name and extension created by a user. The file extension is duplicated following a delimiter to preserve a users ability to search for the original file name and extension, while maintaining functional identification of the file type to the operating and/or file system.

A typical embodiment of the invention comprises a computer program embodied on a computer readable medium, including program instructions for generating metadata for a file name, the file name including in order an original name a delimiter and a file extension and program instructions for adding the metadata to the file name to form a new file name such that the new file name includes the original name, the delimiter and the file extension in order and the metadata and a duplicate of the delimiter and the file extension, the duplicate of the delimiter and the file name extension in order being disposed at an end of the new file name to maintain functional identification.

The metadata may comprise a left padded number and/or a monotonically increasing number. In further embodiments, the metadata may also comprise a time stamp. The program instructions for generating and adding the metadata may be implemented in conjunction with a file replication and versioning software application. In addition, a portion of the metadata may be used to identify the new file name to a compatible software application.

Further embodiments may include program instructions for determining a highest previously applied metadata number to one or more existing file names within a directory. The generated metadata comprises a next higher metadata number than the highest previously applied metadata number. The one or more existing file names within the directory may comprise only files names having a common original name. Alternately, the one or more existing file names within the directory comprise all of the existing file names within the directory or only file names having a common file type within the directory.

Similarly, an exemplary method embodiment of the invention comprises the generating metadata for a file name, the file name including in order an original name a delimiter and a file extension and adding the metadata to the file name to form a new file name such that the new file name includes the original name, the delimiter and the file extension in order and the metadata and a duplicate of the delimiter and the file extension, the duplicate of the delimiter and the file name extension in order being disposed at an end of the new file name to maintain functional identification. The method may be further modified consistent with the computer program embodiment.

### BRIEF DESCRIPTION OF THE DRAWINGS

Referring now to the drawings in which like reference numbers represent corresponding parts throughout:

FIG. 1 is a block diagram of a hardware environment suitable for implementing embodiments of the invention;

FIG. 2 illustrates the technique for non-disruptive encoding of metadata into file names;

FIG. 3A illustrates generating metadata differentiated only among files names having a common original name within a directory;

FIG. 3B illustrates generating metadata differentiated among all file names within a directory;

FIG. 3C illustrates generating metadata based on a time stamp from a system clock;

FIG. 3D illustrates generating metadata differentiated only among files names having a common file type within a directory;

FIG. 4A is a flowchart of an exemplary method of non-disruptive encoding of metadata into a file name;

FIG. 4B is a flowchart of an exemplary method of non-disruptive encoding of metadata into a file name including file analysis differentiating only among files names having a common original name within a directory;

FIG. 4C is a flowchart of an exemplary method of non-disruptive encoding of metadata into a file name including file analysis differentiating among all file names within a directory;

FIG. 4D is a flowchart of an exemplary method of non-disruptive encoding of metadata into a file name including file analysis differentiating among only among file types within a directory;

FIG. 5A illustrates a computer system implementing an embodiment of the invention through a file system application showing all file names including metadata; and

FIG. 5B illustrates a computer system implementing an embodiment of the invention through a file system application showing only the original names.

### DETAILED DESCRIPTION OF THE PREFERRED EMBODIMENT

In the following description of the invention, which includes a description of the preferred embodiment, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

1. Hardware Environment

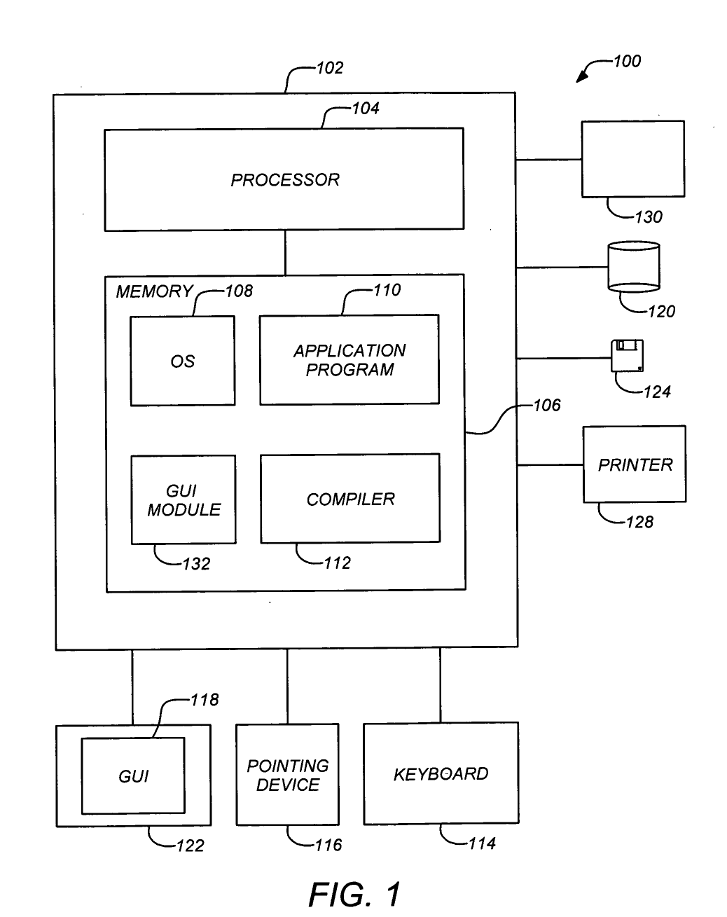

FIG. 1 illustrates an exemplary computer system 100 that can be used to implement selected modules and/or functions of the present invention. The computer 102 comprises a processor 104 and a memory 106, such as random access memory (RAM). The computer 102 is operatively coupled to a display 122, which presents images such as windows to the user on a graphical user interface 118. The computer 102 may be coupled to other devices, such as a keyboard 114, a mouse device 116, a printer, etc. Of course, those skilled in the art will recognize that any combination of the above components, or any number of different components, peripherals, and other devices, may be used with the computer 102.

Generally, the computer 102 operates under control of an operating system 108 (e.g. OS/2, LINUX, UNIX, WINDOWS, MAC OS) stored in the memory 106, and interfaces with the user to accept inputs and commands and to present results, for example through a graphical user interface (GUI) module 132. Although the GUI module 132 is depicted as a separate module, the instructions performing the GUI functions can be resident or distributed in the operating system 108, the computer program 110, or implemented with special purpose memory and processors. The computer 102 also implements a compiler 112 which allows an application program 110 written in a programming language such as C, C++, JAVA, ADA, BASIC, VISUAL BASIC or any other programming language to be translated into code readable by the processor 104. After completion, the computer program 110 accesses and manipulates data stored in the memory 106 of the computer 102 using the relationships and logic that was generated using the compiler 112. The computer 102 also optionally comprises an external data communication device 130 such as a modem, satellite link, ethernet card, or other device for communicating with other computers, e.g. via the Internet.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc 124, hard drive, DVD/CD-rom, digital tape, etc. Further, the operating system 108 and the computer program 110 comprise instructions which, when read and executed by the computer 102, cause the computer 102 to perform the steps necessary to implement and/or use the present invention. Computer program 110 and/or operating system 108 instructions may also be tangibly embodied in the memory 106 and/or transmitted through or accessed by the data communication device 130. As such, the terms “article of manufacture,” “program storage device” and “computer program product” as may be used herein are intended to encompass a computer program accessible and/or operable from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

2. Non-Disruptive Encoding of Metadata into File Name

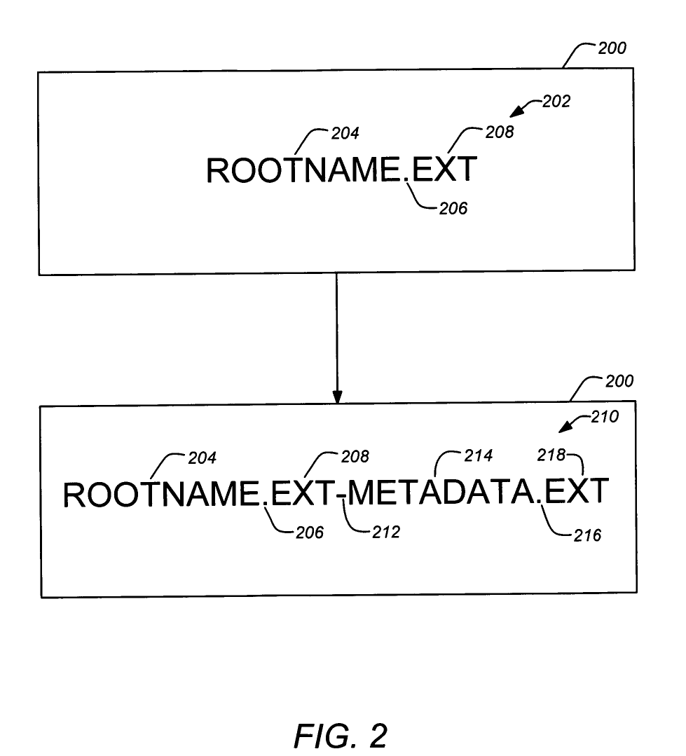

FIG. 2 illustrates the technique for non-disruptive encoding of metadata into file names employed with embodiments of the invention. The technique begins with a file 200 within a directory on a computer storage device having an original file name 202 created by a user. The original file name 202 comprises in order a root name 204, a delimiter 206 (typically a dot or period, “.”) and a file extension 208. Embodiments of the invention apply a new name 210 to the file 200 having the following structure. The new name 210 comprises in order the root name 204, the delimiter 206 and the file extension 208 of the original file name 202. Appended to this is the metadata 214, which may be separated from the file extension 208 by another delimiter 212, e.g. a hyphen. Following this, a duplicate delimiter 216 and duplicate file extension 218 are disposed in order.

The combination of employing both the original file name 202, including exact and complete syntax originally defined by the user (i.e. root name 204, delimiter 206 and file extension 208 in order) as well as a duplicate delimiter 216 and file extension 218 in order at the end of the new name 210 allows a combination of benefits. A user may perform natural searches for the name (including the file extension) as it was originally defined. In addition, because the file extension is duplicated at the end, functional identification of the file type to the file and/or operating system is maintained.

As a unique name must be employed for files stored within the same directory, some technique for making sure the files are differentiated as new names 210 are created. The metadata which is added to the file name can be generated in a manner to distinguish the files. For example, the metadata 214 employed may comprise a left padded number (e.g. left padded with zeros) and/or a monotonically increasing number. In other embodiments, the metadata 214 may comprise a time stamp. Embodiments of the invention may generate the metadata by determining a highest previously applied metadata number to one or more existing file names within a directory. The generated metadata then comprises a next higher metadata number than the highest previously applied metadata number.

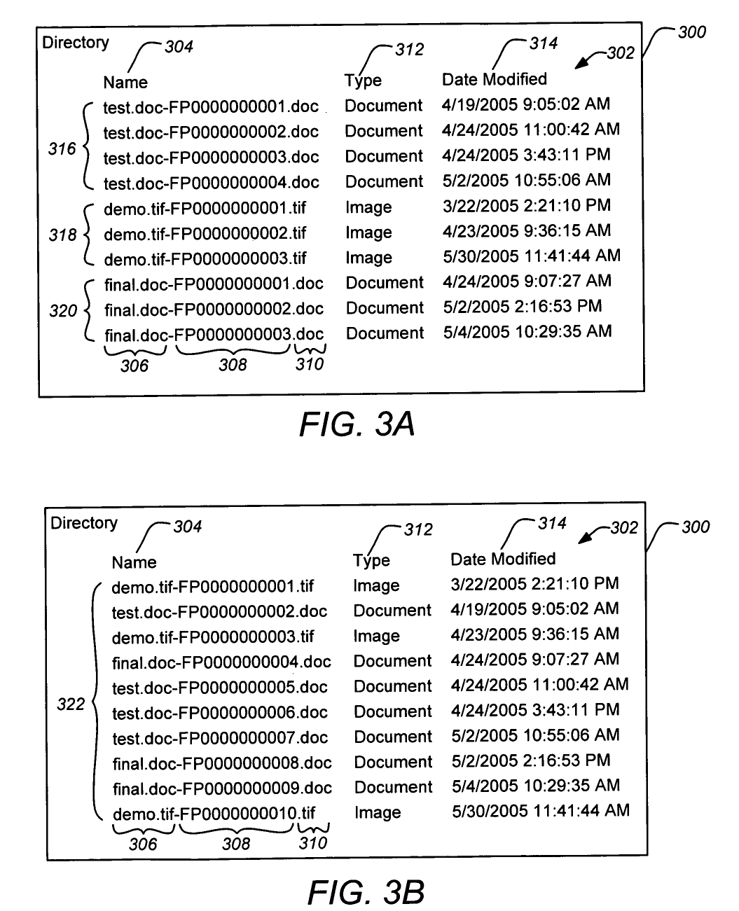

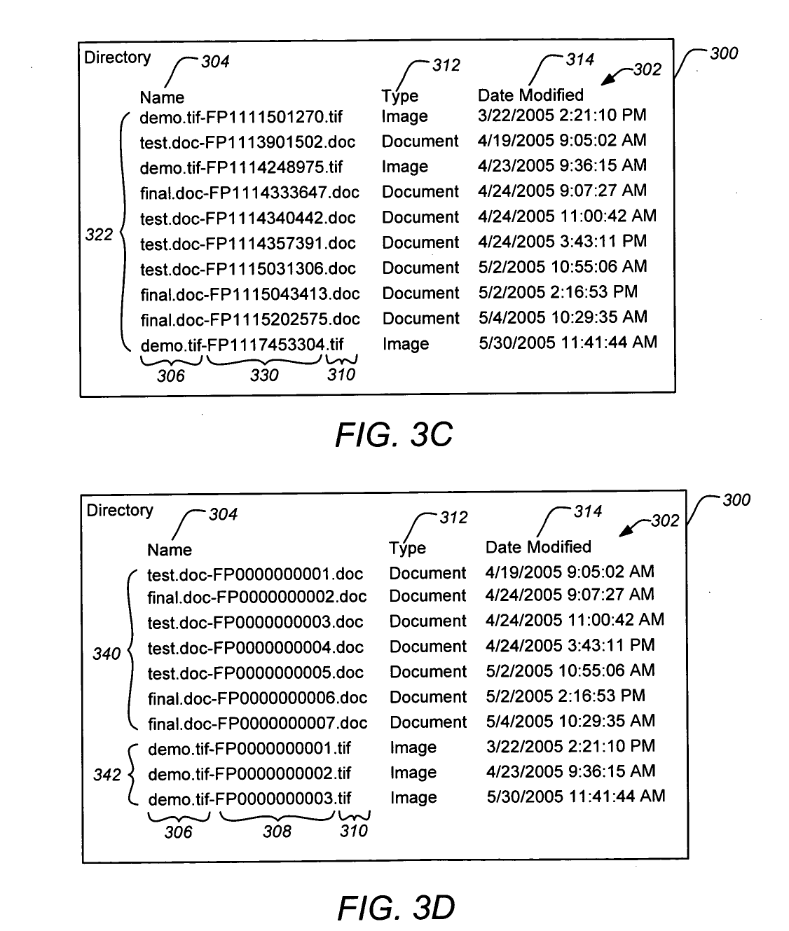

FIG. 3A illustrates generating metadata differentiated only among files names having a common original name within a directory 300. The directory 300 shows a list of files 302. The files 302 each have a name 304 which includes the complete original name 306, metadata 308 and the duplicated file extension 310 as described above. In addition, the files 302 each are designated by file type 312, determined by the duplicated file extension 310 of the complete original name 306, and by a time stamp 314, indicating the last time the specific file was modified. In this case where metadata is generated differentiated only among file names having a common original name within the directory, groups of files 316, 318, 320 are identified based upon having a common complete original name 306.

In the example, three such groups 316, 318, 320 are shown, a first group 316 for all files having “test.doc” as the complete original name, a second group 318 for all files having “demo.tif” as the complete original name, and a third group 320 for all files having “final.doc” as the complete original name. Within each group 316, 318, 320 metadata 308 is added corresponding to a left padded number monotonically increasing number; each later modified file having the same complete original name has the next higher metadata 308 number. For example, the four files of the first group 316 having “test.doc” as the complete original name have metadata of “FP0000000001” to “FP0000000004” added to each in order of their time stamps. Thus, for a newly modified or created file, metadata is generated by determining a highest previously applied metadata number to one or more existing file names having a common original name within the directory. The generated metadata then comprises a next higher metadata number than the highest previously applied metadata number. Incidentally, within each group 316, 318, 320, the metadata 308 numbers are ordered with the time stamps 314 because the metadata 308 is generated with each newly modified or created file relative to the previous modified or created file. (It should be noted that inherently, if a highest previously applied metadata number to one or more existing file names having a common original name within a directory does not exist, then the next higher metadata number than the highest previously applied metadata number is the first number.)

It should also be noted that a portion of the metadata, e.g. the first two digits, may be used to encode other information. For example, a portion of the metadata may be used to identify the new file name (and particularly, the remainder of the metadata) to a compatible software application in a manner similar to how a file extension identifies files to compatible applications. In the examples provided herein, “FP” may designate the software application (e.g. FilePath) which generated and added the metadata. From this designator, software applications such as FilePath, can readily identify the new file name format and further decode and/or manipulate the remainder of the file name and/or metadata. In general, the metadata itself is not limited to any particular encoding purpose or format; a range of uses and formats, alone or in combination will be apparent to those skilled in the art.

FIG. 3B illustrates generating metadata differentiated among all file names within a directory 300. The basic structure of the directory 300, files 302 each have a name 304 which includes the complete original name 306, metadata 308 and the duplicated file extension 310 are as described above with respect to FIG. 3A. The files 302 each are designated by file type 312, determined by the duplicated file extension 310 of the complete original name 306, and by a date stamp 314, indicating the last time the specific file was modified. In this case, for a newly modified or created file, metadata is generated by determining a highest previously applied metadata number among all the existing file names 322 within the directory 300. The generated metadata then comprises a next higher metadata number than the highest previously applied metadata number. In the example, metadata 308 is applied to each of the files 302 from “FP0000000001” to “FP0000000010”. Here also, the order of the metadata 308 numbers corresponds to the order of time stamps 314 because the metadata 308 is generated with each newly modified or created file relative to the previous modified or created file. However, the ordering here applies across all the existing file names 322, not within separate defined groups. (Just as above, if a highest previously applied metadata number to any of all existing file names within a directory does not exist, then inherently the next higher metadata number than the highest previously applied metadata number is the first number.)

FIG. 3C illustrates generating metadata based on a time stamp from a system clock. Here too, the basic structure of the directory 300, files 302 each have a name 304 which includes the complete original name 306, metadata 330 and the duplicated file extension 310 are as described above with respect to FIG. 3A. The files 302 each are designated by file type 312, determined by the duplicated file extension 310 of the complete original name 306, and by a date stamp 314, indicating the last time the specific file was modified. This technique operates essentially the same as that shown in FIG. 3B except that the metadata 330 itself is actually a time stamp, rather than merely a montonically increasing number. Thus, for a newly modified or created file, metadata is generated by simply applying the time stamp of the newly modified or created file as the metadata 330.

For example, a timestamp may comprise the number of seconds since 1970 based on the current system clock. In this case, the stamp has no human perceivable relationship to a real date or time. Using seconds (or anything that increases) is good for preserving sort order. In the example, metadata 330 for the “demo.tif” file modified Mar. 22, 2005, 2:21:10 PM is “FP1111501270,” corresponding to the number of seconds since the beginning of 1970 (including leap years). It is important to note that this time stamp format for the metadata 330 is only one example to illustrate the principle and many other formats are possible. For example, other time stamp formats may be used, such as a number corresponding to the year (YY), month (MM), day (DD) and 24 hr (HHmmss) time in order (i.e. FPYYMMDDHHmmss). Furthermore, the metadata may comprise a four digit year (YYYY, e.g. 2005). Obviously here, the order of the metadata 308 numbers corresponds to the order of time stamps 314 because the metadata 308 is generated representing the time stamp of each file. As with FIG. 3B, the ordering here applies across all the existing file names 322, not only within separate defined groups.

FIG. 3D illustrates yet another technique of generating metadata differentiated only among files names having a common file type within a directory. Again, the basic structure of the directory 300, files 302 each have a name 304 which includes the complete original name 306, metadata 308 and the duplicated file extension 310 are as described above with respect to FIG. 3A. The files 302 each are designated by file type 312, determined by the duplicated file extension 310 of the complete original name 306, and by a date stamp 314, indicating the last time the specific file was modified. In this case, files are grouped by type as determined by the file extension 310 in order to generate metadata 308.

In the given example two groups 340, 342 are shown, a first group 340 for all document files having “doc” as the file extension and a second group 342 for all image files having “tif” as the file extension. Within each group 340, 342 metadata 308 is added corresponding to a left padded number monotonically increasing number; each later modified file having the file extentsion has the next higher metadata 308 number. For example, the seven files of the first group 340 having “doc” as the file extension have metadata of “FP0000000001” to “FP0000000007” added to each in order of their time stamps. The foregoing techniques for generating and adding metadata to file names illustrated in FIGS. 3A-3D can be described by the following method flowcharts.

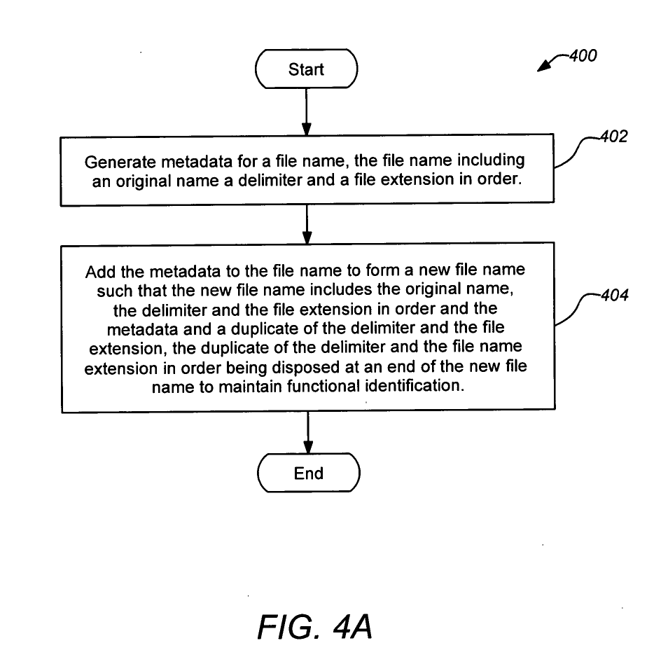

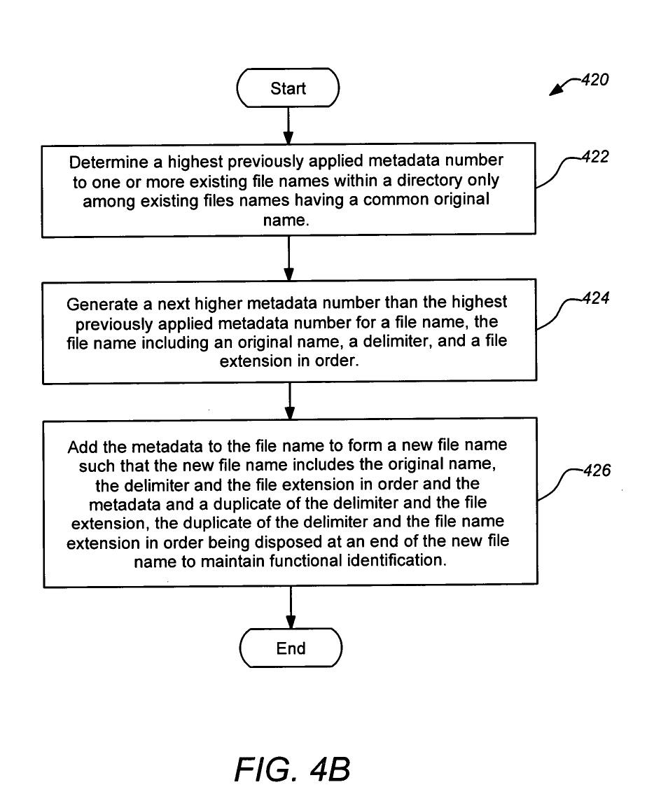

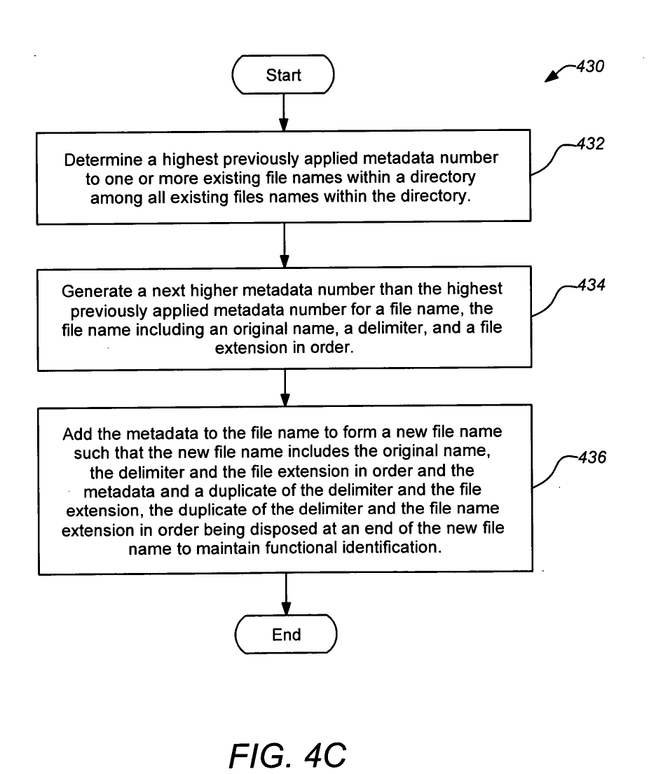

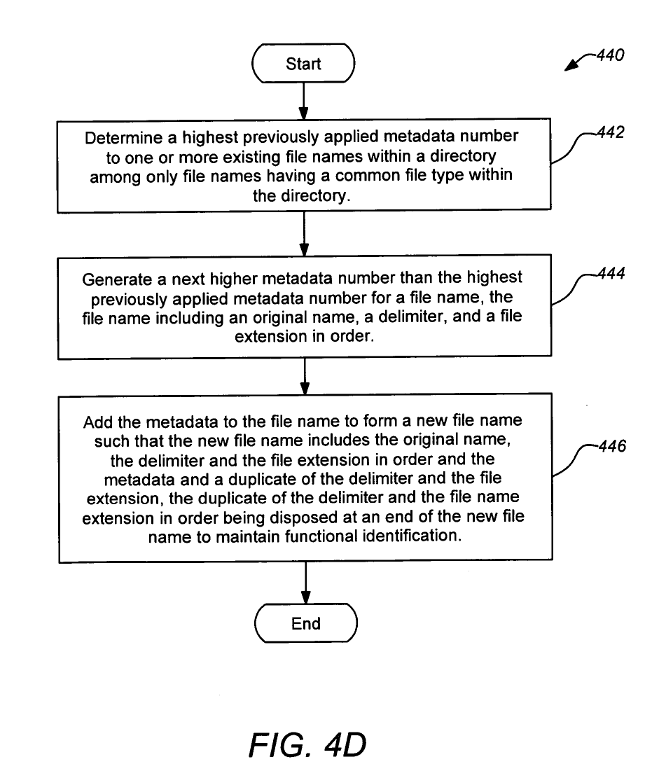

FIG. 4A is a flowchart of an exemplary method 400 of non-disruptive encoding of metadata into a file name. The method 400 begins with the operation 402 of generating metadata for a file name. The file name includes an original name a delimiter and a file extension in order. Next at operation 404, the metadata is added to the file name to form a new file name such that the new file name includes the original name, the delimiter and the file extension in order and the metadata and a duplicate of the delimiter and the file extension. The duplicate of the delimiter and the file name extension in order are disposed at an end of the new file name to maintain functional identification. Note that this method 400 illustrates the technique of FIG. 3C where the generated metadata corresponds to the file time stamp.

FIG. 4B is a flowchart of another exemplary method 420 of non-disruptive encoding of metadata into a file name including file analysis differentiating only among files names having a common original name within a directory as previously illustrated in FIG. 3A. The method begins with a procedure 422 of determining a highest previously applied metadata number to one or more existing file names within a directory only among existing files names having a common original name. At procedure 424, a next higher metadata number than the highest previously applied metadata number for a file name is generated. The file name includes an original name, a delimiter, and a file extension in order. Finally, procedure 426 adds the metadata to the file name to form a new file name such that the new file name includes the original name, the delimiter and the file extension in order and the metadata and a duplicate of the delimiter and the file extension. The duplicate of the delimiter and the file name extension are disposed in order at an end of the new file name to maintain functional identification.

FIG. 4C is a flowchart of a third exemplary method 430 of non-disruptive encoding of metadata into a file name including file analysis differentiating among all file names within a directory as previously illustrate in FIG. 3B. This method 430 is the same as the method 420 of FIG. 4B except that the highest previously applied metadata number is determined from among all existing file names within the directory. Thus the method 430 begins with a procedure 432 of determining a highest previously applied metadata number to one or more existing file names within a directory among all existing files names with the directory. At procedure 434, a next higher metadata number than the highest previously applied metadata number for a file name is generated. The file name includes an original name, a delimiter, and a file extension in order. Finally, procedure 436 adds the metadata to the file name to form a new file name such that the new file name includes the original name, the delimiter and the file extension in order and the metadata and a duplicate of the delimiter and the file extension. The duplicate of the delimiter and the file name extension are disposed in order at an end of the new file name to maintain functional identification.

FIG. 4D is a flowchart of a fourth exemplary method 440 of non-disruptive encoding of metadata into a file name including file analysis differentiating among only among file types within a directory as previously illustrated in FIG. 3D. This method 440 is the same as the method 420 of FIG. 4B except that the highest previously applied metadata number is determined from only among files within the directory having the same file type, i.e. the same file extension. The method 440 begins with a procedure 442 of determining a highest previously applied metadata number to one or more existing file names within a directory among only file names having a common file type within the directory. At procedure 444, a next higher metadata number than the highest previously applied metadata number for a file name is generated. The file name includes an original name, a delimiter, and a file extension in order. Finally, procedure 446 adds the metadata to the file name to form a new file name such that the new file name includes the original name, the delimiter and the file extension in order and the metadata and a duplicate of the delimiter and the file extension. The duplicate of the delimiter and the file name extension are disposed in order at an end of the new file name to maintain functional identification.

3. File Management Software Application

Now referring back to FIG. 1, in general, embodiments of the invention may be implemented as part of the operating system 108 of the computer 102 which implements the management of files stored on the data storage device 120. Alternately, embodiments of the invention may be implemented as part of a separate software application, e.g. a file system application such as a file replication and versioning software application.

For example, embodiments of the invention can be implemented for use in a file replication and versioning system, e.g. VITAFILE or FILEPATH®. Such a system can employ an embodiment of the invention encoding content addressable storage (CAS) of information, file version information and file replication information. The versioning feature of such a system can make a “version” of a file as the user saves changes to that file. A version is a copy of a file as it was last saved prior to making any newly saved changes. The system can store versions of files in a target director; all versions of a given file are stored in the same directory and hence require a unique name.

In an exemplary embodiment of the invention, the user may create a original file name having an extension, ROOTNAME.EXT, where ROOTNAME is the file name and EXT is the file name extension, which is typically employed to identify the file type to the operating system or file system. The system which may implement embodiments of the invention may thereafter convert the original file name to ROOTNAME.EXT-METADATA.EXT, adding metadata and a repitition of the file name extension to the original file name. The metadata may be a monotonically increasing number (similar to a timestamp), that is left padded and provides an important value of keeping the files listed in creation-date order when sorted merely by their file names. For example, a user may create a file, “test.doc”, a document file named test. The file system may convert this file to “test.doc-FP0000000001.doc”. Alternately, the metadata may literally comprise a time stamp such that the files are listed in creation-date order when sorted by their file names. See the detailed examples of section 2, above.

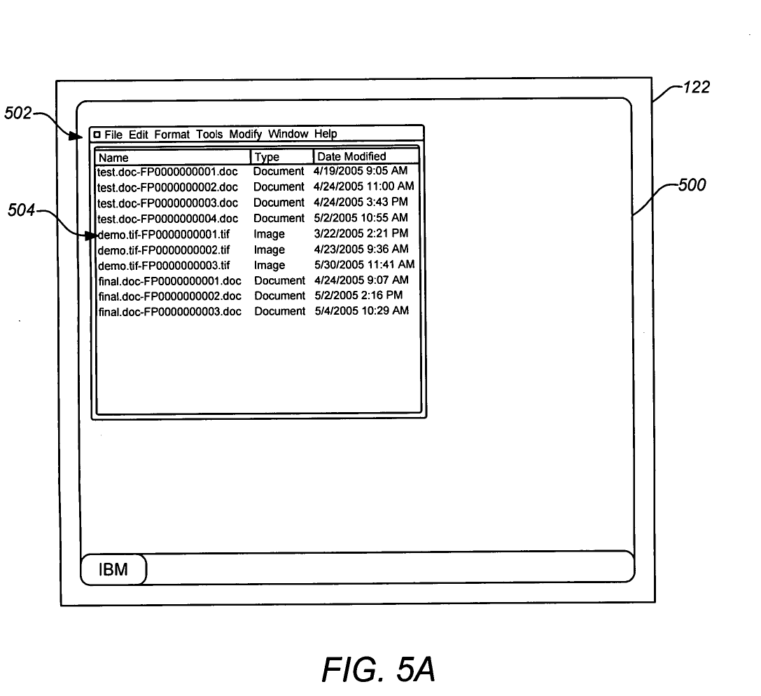

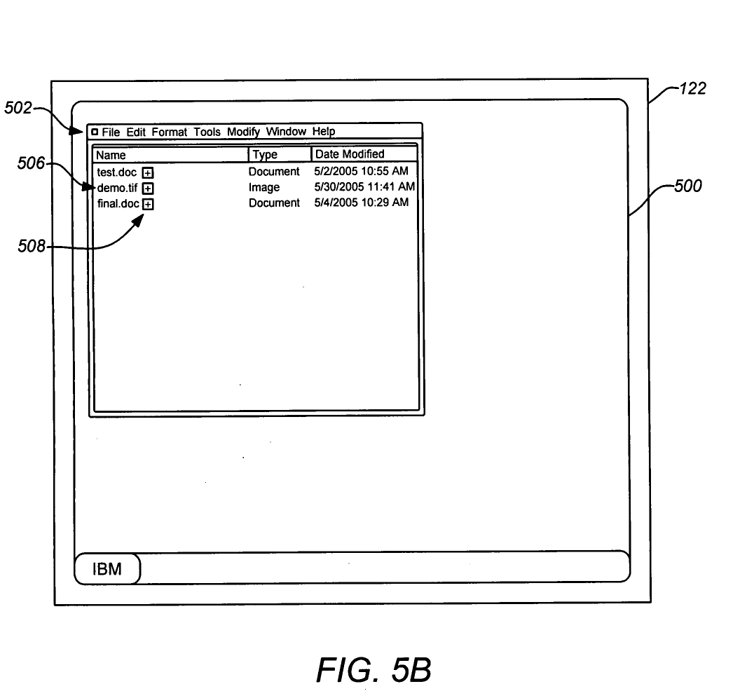

FIG. 5A illustrates a computer system implementing an embodiment of the invention through a file system application showing all file names including metadata. In this example, the computer display 122 presents the GUI 500 which includes a main window of the file management application 502. The file management application 502 displays a full listing view 504 of the files in a directory showing the file names (including the nondisruptively encoded metadata) as well as the file type and time stamp information.

FIG. 5B illustrates a computer system implementing an embodiment of the invention through a file system application showing only the original names. Here a more manageable filtered view 506 is presented because the user only sees the original names which were presumably created by the user and are perhaps the only familiar component of the new names which have the metadata added by the system. The multiple versions of each original file name are, at least temporarily, filtered from view. In this case, the relationship between the shown original names and the underlying metadata-distinguished multiple files is similar to the relationship between a main directory and a subdirectory in ordinary file management. All the files having a common original name may be viewed by “entering” (e.g. clicking on) the original name, e.g. as indicated by the plus sign icon 508.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for generating metadata for a file name, the file name including in order an original name a delimiter and a file extension; and
program instructions for adding the metadata to the file name to form a new file name such that the new file name includes the original name, the delimiter and the file extension in order and the metadata and a duplicate of the delimiter and the file extension, the duplicate of the delimiter and the file name extension in order being disposed at an end of the new file name to maintain functional identification.

2. The computer program of claim 1, wherein the metadata comprises a left padded number.

3. The computer program of claim 1, wherein the metadata comprises a monotonically increasing number.

4. The computer program of claim 1, wherein a portion of the metadata identifies the new file name to a compatible software application.

5. The computer program of claim 1, wherein the metadata comprises a time stamp.

6. The computer program of claim 1, wherein the program instructions for generating and adding the metadata are implemented in conjunction with a file replication and versioning software application.

7. The computer program of claim 1, further comprising program instructions for determining a highest previously applied metadata number to one or more existing file names within a directory;
wherein the generated metadata comprises a next higher metadata number than the highest previously applied metadata number.

8. The computer program of claim 7, wherein the one or more existing file names within the directory comprise only files names having a common original name.

9. The computer program of claim 7, wherein the one or more existing file names within the directory comprise all of the existing file names within the directory.

10. The computer program of claim 7, wherein the one or more existing file names within the directory comprise only file names having a common file type within the directory.

11. A method, comprising:
generating metadata for a file name, the file name including in order an original name a delimiter and a file extension; and
adding the metadata to the file name to form a new file name such that the new file name includes the original name, the delimiter and the file extension in order and the metadata and a duplicate of the delimiter and the file extension, the duplicate of the delimiter and the file name extension in order being disposed at an end of the new file name to maintain functional identification.

12. The method of claim 11, wherein the metadata comprises a left padded and monotonically increasing number.

13. The method of claim 11, wherein a portion of the metadata identifies the new file name to a compatible software application.

14. The method of claim 11, wherein the metadata comprises a time stamp.

15. The method of claim 11, wherein generating and adding the metadata is implemented in conjunction with a file replication and versioning software application.

16. The method of claim 11, further comprising determining a highest previously applied metadata number to one or more existing file names within a directory;
wherein the generated metadata comprises a next higher metadata number than the highest previously applied metadata number.

17. The method of claim 16, wherein the one or more existing file names within the directory comprise only files names having a common original name.

18. The method of claim 16, wherein the one or more existing file names within the directory comprise all of the existing file names within the directory.

19. The method of claim 16, wherein the one or more existing file names within the directory comprise only file names having a common file type within the directory.

20. A computer program embodied on a computer readable medium, comprising:
program instructions for generating metadata for a file name, the file name including in order an original name a delimiter and a file extension; and
program instructions for adding the metadata to the file name to form a new file name such that the new file name includes the original name, the delimiter and the file extension in order and the metadata and a duplicate of the delimiter and the file extension, the duplicate of the delimiter and the file name extension in order being disposed at an end of the new file name to maintain functional identification
wherein the metadata comprises a left padded and monotonically increasing number and a portion of the metadata identifies the new file name to a compatible software application.
